(19) United States
(12) Patent Application Publication
(10) Pub. No.: US 2005/0189670 A1
(43) Pub. Date: Sep. 1, 2005

(54) Method for manufacturing lustrous rubber

(76) Inventors: Liu Kuang Hong, Jung He City (TW); Ma Chih Hung, Miau Li Hsien (TW); Tsai Yung-Jen, Chang Hwa Hsien (TW); Hsieh Hsien Jung, Chang Hwa Hsien (TW)

Correspondence Address: CHARLES E. BAXLEY, ESQ., 90 JOHN STREET, THIRD FLOOR, NEW YORK, NY, 10038, US

(21) Appl. No.: 10/791,445

(22) Filed: Mar. 1, 2004

(51) Int. Cl. B29C 47/00

(52) U.S. Cl. 264/75; 264/140; 264/78; 264/349

(57) ABSTRACT

A method for manufacturing lustrous rubber includes: Step 1: choose rubber of different colors; Step 2: add 1-100 g pearl pigment to each 1 kg rubber; Step 3: mix the above combination; Step 4: cool the above mixture for 2 hours; Step 5: cut the above mixture into grains; Step 6: vulcanize and extrude the above grains for 4 minutes 30 seconds to 5 minutes 30 seconds; Step 7: the lustrous rubber is finished. Thus, lustrous colorful rubber can be manufactured through the above 7 steps, and figures can be produced too.

### BACKGROUND OF THE INVENTION

1. Field of the Invention

The present invention relates to a method for manufacturing lustrous rubber, and more particularly to a method including 7 steps which are used to vulcanize and extrude the raw rubber of different colors, through which a product of lustrous rubber with predetermined figures can be obtained.

2. Description of the Prior Arts

With the development of science, rubber-molding technology has become one of the most important technologies in current high-tech industry. However, due to the methods and steps of rubber molding are different, how to manufacture competitive rubber product is what the producers concern most, and also this is the motivation of the inventor of the present invention.

The present invention has arisen to mitigate and/or obviate the afore-described disadvantages of the conventional method for manufacturing rubber.

### SUMMARY OF THE INVENTION

The primary object of the present invention is to provide a method for manufacturing lustrous rubber, which includes 7 steps, and which includes the Step 2: add 1-100 g pearl pigment to each 1 kg rubber; the Step 3: mix the above combination; and the Step 4: cool the above mixture for 2 hours; these 3 steps of step 2, 3 and 4 can be used to manufacture lustrous rubber.

Another object of the present invention is able to provide a method for manufacturing lustrous rubber with desired figures, which includes Step 1: choose rubber of different colors; Step 5: cut the above mixture into grains; and Step 6: vulcanize and extrude the above grains for 4 minutes 30 seconds to 5 minutes 30 seconds; these 3 steps of step 1, 5 and 6 can be used to manufacture lustrous rubber with desired figures.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a flow chart for illustrating a method of manufacturing lustrous rubber in accordance with one aspect of the present invention;

FIG. 2 is an illustrative view for showing the step of adding rubber to pearl pigment;

FIG. 3 is an illustrative view for showing the step of cutting the rubber into grains;

FIG. 4 is an illustrative view for showing the step for vulcanizing and extruding the rubber grains;

FIG. 5 is an illustrative view for showing the final product of lustrous rubber.

### DETAILED DESCRIPTION OF THE PREFERRED EMBODIMENT

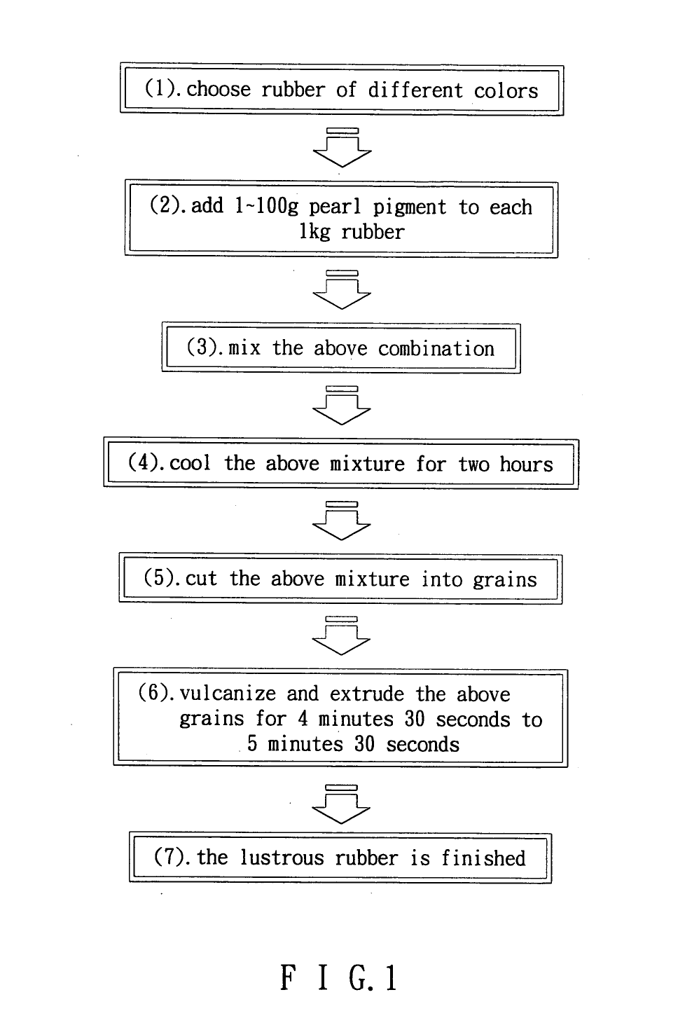

Referring to FIG. 1, which is a flow chart for illustrating a method of manufacturing lustrous rubber in accordance with one aspect of the present invention, wherein the method of manufacturing lustrous rubber includes the following steps:

A manufacturing method of lustrous rubber includes:
Step 1: choose rubber of different colors;
Step 2: add 1-100 g pearl pigment to each 1 kg rubber;
Step 3: mix the above combination;
Step 4: cool the above mixture for 2 hours;
Step 5: cut the above mixture into grains;
Step 6: vulcanize and extrude the above grains for 4 minutes 30 seconds to 5 minutes 30 seconds;
Step 7: the lustrous rubber is finished.

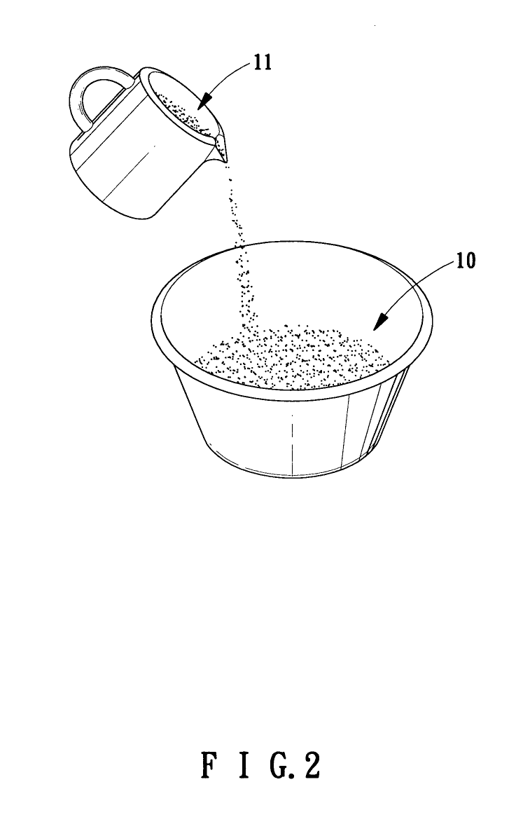

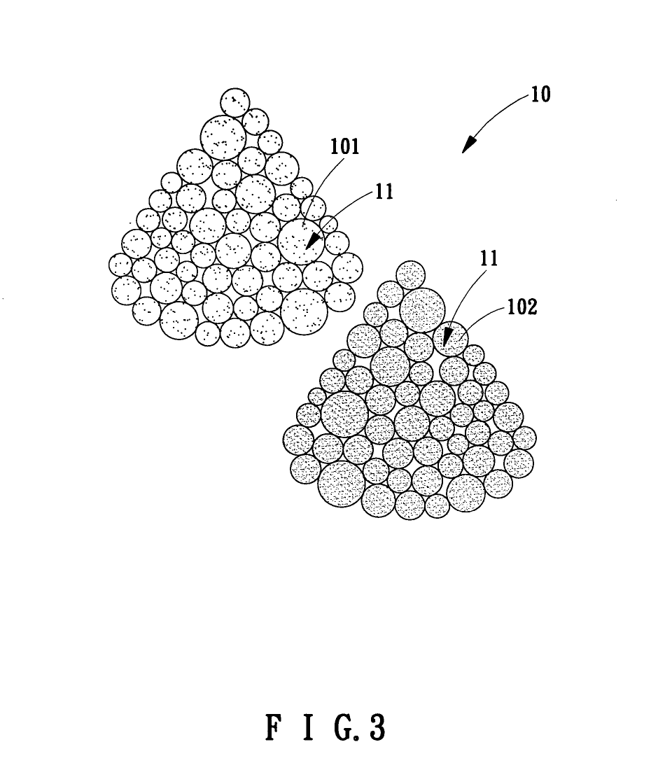

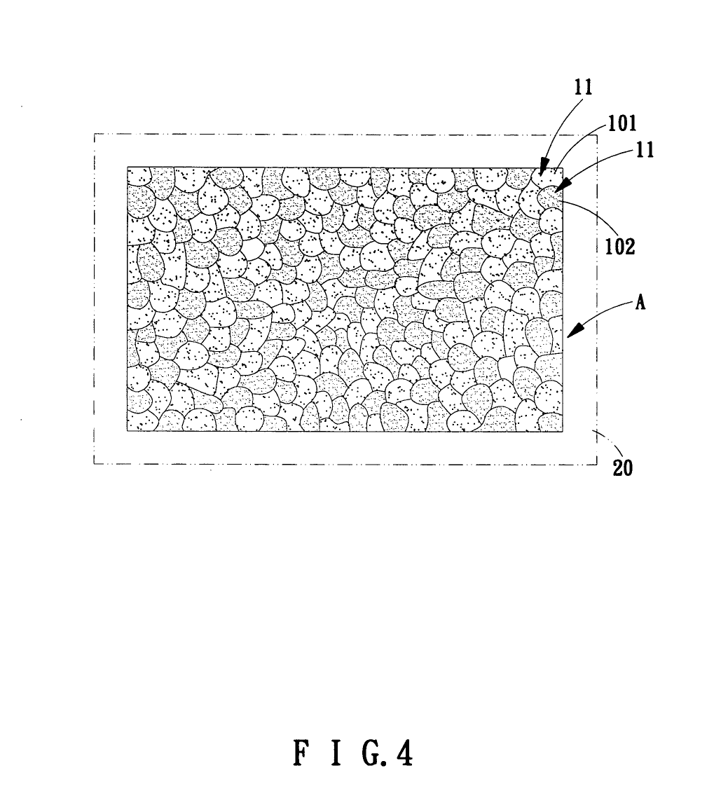

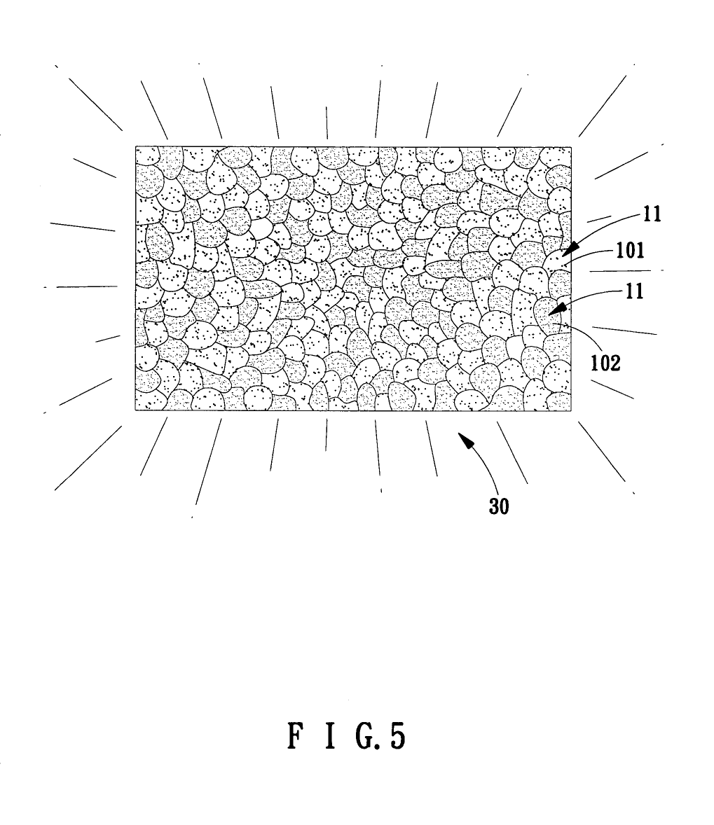

Referring further to FIGS. 2-5, which are illustrative views for showing the steps of manufacturing the lustrous rubber:
Step 1: choose rubber of different colors: choose rubber (10) of different colors on the basis of predetermined figures (using the rubber 10 of two different colors as an example in this embodiment);
Step 2: add 1-100 g pearl pigment to each 1 kg rubber: as shown in FIG. 2, add the pearl pigment 11 respectively to the rubber 10 of different colors, and the rate for adding the pearl pigment is: 2 g pearl pigment 11 per 1 kg rubber 10;
Step 3: mix the pearl pigment with the rubber: respectively mix the rubber 10 of different colors evenly with the pearl pigment 11, such that the pearl pigment 11 is evenly distributed in the rubber 10;
Step 4: cool the above mixture for 2 hours: cool the mixture of the rubber 10 and the pearl pigment 11 for 2 hours;
Step 5: cut the above mixture into grains: as shown in FIG. 3, cut the above mixture into desire-sized grains 101, 102 of two colors;
Step 6: vulcanize and extrude the above grains for 4 minutes 30 seconds to 5 minutes 30 seconds: as shown in FIG. 4, combine the grains of two different colors 101, 102 together, and then vulcanize and extrude the combination of the grains 101, 102 with a machine 20 for 4 minutes 30 seconds to 5 minutes 30 seconds;
Step 7: the lustrous rubber is finished: as shown in FIG. 5, after the step of vulcanization and extrusion, lustrous rubber 30 is obtained.

It will be noted that the producer can choose the rubber 10 of different colors according to predetermined figures. If the predetermined figures are marble grain, the colors will be black and white (with reference to FIG. 5), and if the predetermined figures are camouflage pattern, then the colors of the rubber 10 can be black, green and yellow. The products of colorful lustrous rubber 30 with different figures will be more competitive and has greater applicability comparing to conventional rubber products.

While we have shown and described various embodiments in accordance with the present invention, it should be clear to those skilled in the art that further embodiments may be made without departing from the scope of the present invention.

1. A method for manufacturing lustrous rubber comprising the following steps:
Step 1: choosing rubber of different colors: choosing rubber of 5 different colors based on predetermined figures;
Step 2: adding 1-100 g pearl pigment to each 1 kg rubber: adding the pearl pigment respectively to the rubber of different colors, and rate for adding the pearl pigment is: 1-100 g pearl pigment 11 per 1 kg rubber 10;
Step 3: mixing the pearl pigment with the rubber: respectively mixing the rubber of different colors evenly with the pearl pigment, so to evenly distribute the pearl pigment in the rubber;
Step 4: cooling the mixture of the rubber of different colors and the pearl pigment for 2 hours: cooling the mixture of the rubber different colors and the pearl pigment for 2 hours;
Step 5: cutting the mixture of the rubber different colors and the pearl pigment into grains: cutting the mixture of the rubber of different colors and the pearl pigment into desire-sized grains of different colors;
Step 6: vulcanizing and extruding the desire-sized grains of different colors for 4 minutes 30 seconds to 5 minutes 30 seconds: combining the grains of different colors together, and then vulcanizing and extruding the grains of different colors for 4 minutes 30 seconds to 5 minutes 30 seconds, so as to form predetermined figures with the grains of different colors;
Step 7: achieving lustrous rubber: after step of vulcanization and extrusion, final product of lustrous rubber is obtained.
